(19) United States
(12) Patent Application Publication
(10) Pub. No.: US 2014/0164048 A1
(43) Pub. Date: Jun. 12, 2014

(54) SCALABLE WEIGHT-AGNOSTIC MULTI-OBJECTIVE QOS OPTIMIZATION FOR WORKFLOW PLANNING

(71) Applicant: XEROX CORPORATION, Norwalk, CT (US)

(72) Inventors: Julien Jean Lucien Bourdaillet, Rochester, NY (US); Yasmine Charif, Rochester, NY (US)

(73) Assignee: XEROX CORPORATION, Norwalk, CT (US)

(21) Appl. No.: 13/708,062

(22) Filed: Dec. 7, 2012

(51) Int. Cl. G06Q 10/06

(52) U.S. Cl. CPC G06Q 10/0633
USPC 705/7.27

(57) ABSTRACT

Disclosed is a method and system for optimizing a workflow planning via the selection of service providers and data centers according to various QoS (Quality of Service) metrics. The algorithm handles multiple QoS parameters and does not require an a priori weighting of their importance, a typical requirement of other approaches to this problem. This is accomplished by using an algorithm that will guarantee that no alternative solution will be strictly better in all QoS criteria than the chosen solution. A variant of the algorithm to specify the preference order among the QoS parameters is also disclosed.

### CROSS REFERENCE TO RELATED PATENTS AND APPLICATIONS

The following copending application, the disclosure of which is incorporated herein in its entirety by reference, is mentioned:

U.S. patent application Ser. No. 13/192,221, filed Jul. 27, 2011 by Jung et al. and entitled “Methods and Systems for Deploying a Service Workflow in a Hybrid Cloud Environment”.

### BACKGROUND

Business processes are typically designed to identify tasks to be performed in order to complete a goal. An end user can generate a business process for a particular workflow using existing tools. The user may then use a business process management (BPM) engine to map the business process into an executable service workflow.

Conventional BPM engines are designed to map a particular business process into an executable service workflow in a single data center. As such, conventional BPM engines are not designed to generate business processes that span multiple data centers, such as a hybrid cloud environment, in a way that minimizes a cost of execution while meeting quality of service requirements.

The Jung et al. patent application Ser. No. 13/192,221, filed Jul. 27, 2011 addresses optimal deployment of workflows on hybrid clouds. However, the disclosed method/system of patent application Ser. No. 13/192,221: 1) requests the user to explicitly specify the global constraints/weights for the criteria, 2) aggregates those constraints into a single criterion which is in fact an ad hoc linear combination of only two metrics (time and cost), 3) finds an optimal solution according to this aggregated criterion in a time complexity that is exponential in the worst case, and thereby 4) misses optimal solutions because of the ad hoc linear combination.

This disclosure provides a method and system for optimizing a workflow planning via the selection of service providers and data centers according to various QoS (Quality of Service) metrics. Crucially, the algorithm handles multiple QoS parameters and does not require an a priori weighting of their importance as may be required of other approaches to this problem. This is accomplished by using an algorithm that will guarantee that no alternative solution will be strictly better in all QoS criteria than the chosen solution. A variant of the algorithm to specify the preference order, i.e. ranking, among the QoS parameters is also provided. Benefits of the disclosed embodiments include its avoidance of the ad hoc specification of QoS weightings, the ability to easily incorporate new QoS parameters, the possibility to provide a preference ranking of QoS parameters when needed, and a reduction in theoretical algorithm complexity via the use of a multi-objective optimization algorithm.

### INCORPORATION BY REFERENCE

U.S. patent application Ser. No. 13/192,221, filed Jul. 27, 2011, by Jung et al. and entitled “Methods And Systems For Deploying A Service Workflow In A Hybrid Cloud Environment”;
M. Ehrgott, X. Gandibleux, An Annotated Bibliography of Multi-Objective Combinatorial Optimization, Report in Wirtschaftsmathematik, Universitat Kaiserslautern, 60 pages, Feb. 15, 2000;
M. Ehrgott, Multi-Criteria Optimization. Lecture in Wirtschaftsmathematik, Universitat Kaiserslautern, 243 pages, 2000;
M. Ehrgott, A Characterization of Lexicographic Max-Ordering Solutions. In Proceedings of the 6th Workshop of the DGOR working group Multi-Criteria Optimization and Decision Theory, pages 1-10, 1997;
K. Kofler, I. ul Haq, E. Schikuta, A Parallel Branch and Bound Algorithm for Workflow QoS Optimization. In Proceedings of the International Conference on Parallel Processing, pages 478-485, 2009;
P. Smith, H. Fingar, Business Process Management (BPM): The Third Wave. ISBN 0-929652-33-9 Off-press, Meghan-Kiffer Press, November 2002; and
G. Zou, Y. Chen, Y. Xiang, R. Huang, Y. Xu, Al Planning and Combinatorial Optimization for Web Service Composition in Cloud Computing. In Proceedings of the International Conference on Cloud Computing and Virtualization, 2010, are all incorporated herein by reference in their entirety.

### BRIEF DESCRIPTION

In one embodiment of this disclosure, described is a method of deploying a service workflow for a business process, the method comprising A) receiving, by a computing device, a service workflow including an ordered plurality of services, each service associated with a plurality of instantiations, and each instance associated with a plurality of data centers to provide the respective instance, each data center associated with one or more QoS properties; B) building a search graph based on the service workflow including a search space of concrete graphs that describe all possible paths of service instances and data centers; C) applying a max ordering function to the search graph to determine the instance and data center for each service; and D) deploying the service workflow to the determined data centers to provide the execution of the service workflow.

In another embodiment of this disclosure, described is a system for deploying a service workflow for a business process, the system comprising a processor; a processor-readable non-transitory storage medium in communication with the processor, the processor-readable non-transitory storage medium containing one or more programming instructions that, when executed, cause the processor to A) receive a service workflow including an ordered plurality of services, each service associated with a plurality of instantiations, and each instance associated with a plurality of data centers to provide the respective instance, each data center associated with one or more QoS properties; B) build a search graph based on the service workflow including a search space of concrete graphs that describe all possible paths of service instances and data centers; C) apply a max ordering function to the search graph to determine the instance and data center for each service; and D) deploy the service workflow to the determined data centers to provide the execution of the service workflow.

In still another embodiment of this disclosure, described is a computer program product comprising a computer-usable non-transitory data carrier storing instructions that, when executed by a computer, cause the computer to perform a method of deploying a service workflow for a business process, the method comprising A) receiving, by a computing device, a service workflow including an ordered plurality of services, each service associated with a plurality of instantiations, and each instance associated with a plurality of data centers to provide the respective instance, each data center associated with one or more QoS properties; B) building a search graph based on the service workflow including a search space of concrete graphs that describe all possible paths of service instances and data centers; C) applying a max ordering function to the search graph to determine the instance and data center for each service; and D) deploying the service workflow to the determined data centers to provide the execution of the service workflow.

### BRIEF DESCRIPTION OF THE DRAWINGS

FIG. 1 illustrates a block diagram of an abstract workflow AW according to an exemplary embodiment of this disclosure.

FIG. 2 illustrates a block diagram of multiple service instances for each abstract service of FIG. 1, where each instance can run on multiple data centers

FIG. 3 illustrates a block diagram of a search space for an exemplary embodiment of a multi-objective optimization algorithm applied to the multiple service instances for each abstract service of FIG. 1 and FIG. 2.

FIG. 4 illustrates a scalar vector of criteria values for traversing an edge Si_{j,d} to Si+1_{j′,d′}.

FIG. 5 illustrates the principle of the decision function (max-ordering optimization) according to an exemplary embodiment of this disclosure.

FIGS. 6A-6C are block diagrams illustrating the principle of the max-ordering decision function when encountering worst criteria equalities.

FIG. 7 is a flow chart illustrating a multi-objective workflow planning optimization algorithm according to an exemplary embodiment of this disclosure.

FIG. 8 is a block diagram illustrating normalization of criteria values.

FIG. 9 is a block diagram of one example of workflow planning according to an exemplary embodiment of this disclosure.

FIG. 10 is a block diagram illustrating the application of an optimization algorithm using the max-ordering decision function to the example of FIG. 9.

FIG. 11 is a block diagram illustrating the application of an optimization algorithm using the lexicographic-max-ordering decision function to the example of FIG. 9, with user preference for (1) privacy, (2) reputation and (3) cost.

FIG. 12 is a block diagram of an exemplary system to execute a multi-objective workflow planning optimization algorithm according to an exemplary embodiment of this disclosure.

### DETAILED DESCRIPTION

The following terms shall have, for the purposes of this application, the respective meanings set forth below.

A “cloud environment” refers to one or more physical and/or logical devices that operate as a shared resource. Logical devices in a cloud environment may be accessed without any knowledge of the corresponding physical devices.

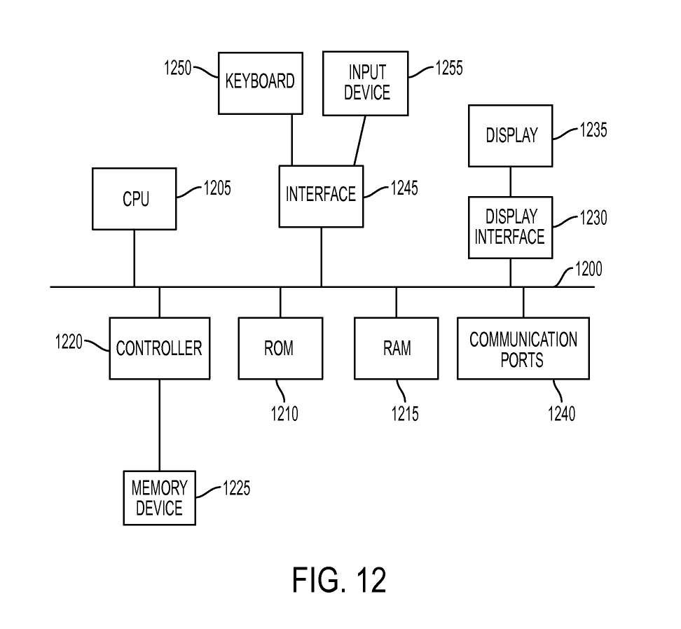

A “computing device” refers to a computer, a processor and/or any other component, device or system that performs one or more operations according to one or more programming instructions. An exemplary computing device is described in reference to FIG. 12.

A “cost value” refers to a cost associated with performing one or more services. A cost value may be determined based one or more cost factors including, without limitation, a cost for using a cloud resource, a cost of purchasing a software license, a power consumption cost, a cost for wear and tear on hardware that is used to perform a particular operation, and the like. The cost may be determined on the basis of a unit of currency or any other metric in which costs are measured.

A “data center” refers to one or more computing devices, memories, and/or other peripheral devices used to perform a service.

An “edge” refers to a logical connection between nodes in a search space used to determine a best path for a workflow. As part of a best path determination, an edge between a first node and a second node may be assigned a network latency associated with a time required to traverse from a data center that is selected to perform a service associated with the first node and a data center that is selected to perform a service associated with the second node.

A “hybrid cloud environment” refers to a cloud computing environment and/or an internal computing environment. A hybrid cloud environment may include one or more data centers located remotely from an entity for which the service workflow is performed and/or one or more data centers located in a computing environment operated by such entity.

A “logical device” is a representation of a physical device that uniquely identifies the corresponding physical device. For example, a network interface may be assigned a unique media access control address that is the logical unique identifier of a physical device. As such, a conventional device is a combined logical and physical device in which the logical device provides the entire identity of the physical device.

A “node” refers to a logical vertex in a search space used to determine a best path for a workflow. Each node may correspond to a data center that is capable of performing a service of a serial sub-workflow or one or more data centers that are capable of performing services of parallel sub-workflows.

A “node list” refers to a group of nodes. A node list may be formed to identify nodes that have been analyzed as part of a search algorithm.

A “physical device” is a physical resource such as a computing device, a computer-readable storage medium and/or the like.

A “print device” refers to a device capable of performing one or more print-related functions. For example, a print device may include a printer, a scanner, a copy machine, a multifunction device, a collator, a binder, a cutter or other similar equipment. A “multifunction device” is a device that is capable of performing two or more distinct print-related functions. For example, a multifunction device may have print and scan capabilities.

A “run-time value” refers to an amount of time required to perform one or more services. A run-time value may include an amount of time incurred as a result of network latencies between nodes performing services.

A “service” refers to a discrete operation performed as part of a workflow. A service may include, for example and without limitation, determining information, calculating a value, performing a physical operation, such as printing, scanning or the like, storing information, and/or any other operation that is typically performed as part of a workflow.

A “utility value” refers to a combined measure of the factors utilized to determine a best path of data centers for performing a workflow.

“Virtualization” is a configuration that allows logical devices to exist as an abstraction without being directly tied to a specific physical device. Virtualization may be achieved using logical names instead of physical identifiers. For example, using a uniform resource locator instead of a server's media access control address effectively virtualizes the target server. Alternatively, an assigned media access control address may exist independently of the physical resources managing network traffic.

A “workflow” or a “service workflow” refers to an ordered list of services used to perform a particular operation. A workflow or service workflow may include one or more services that can each be performed at one or more data centers in a hybrid cloud environment.

As used herein, the terms “sum,” “product” and similar mathematical terms are construed broadly to include any method or algorithm in which a single datum is derived or calculated from a plurality of input data.
Abstract service=Service type, e.g. Translation service, Print service.
Service instance=Implementation of an abstract service by a specific provider, e.g. Bing translator, Google translate.
Concrete service=Service instance executed on/hosted by a data center.
In the context of a multi-objective optimization, we use the terms criterion and objective interchangeably.

Notably, the disclosed method/system is in the context of Business Process workflows (see P. Smith, H. Fingar, Business Process Management (BPM): The Third Wave. ISBN 0-929652-33-9 Off-press, Meghan-Kiffer Press, November 2002), although the disclosure is in principle generally applicable to other types of workflows. Consequently, the terms Workflow and Business Process are used interchangeably throughout the disclosure.

Steady growth of service providers and data centers opens avenues for planning rich, distributed, and efficient service workflows. Without tools that automate the search for a solution, optimal workflow planning would be impractical for a business analyst. This disclosure pertains to the deployment of workflows and their optimal planning for execution on multiple data centers.

In order to optimize workflow planning, current approaches (see G. Zou, Y. Chen, Y. Xiang, R. Huang, Y. Xu, Al Planning and Combinatorial Optimization for Web Service Composition in Cloud Computing. In Proceedings of the International Conference on Cloud Computing and Virtualization, 2010; K. Kofler, I. ul Haq, E. Schikuta, A Parallel Branch and Bound Algorithm for Workflow QoS Optimization, In Proceedings of the International Conference on Parallel Processing, pages 478-485, 2009; and U.S. patent application Ser. No. 13/192,221, filed Jul. 27, 2011, by Jung et al. and entitled “Methods And Systems For Deploying A Service Workflow In A Hybrid Cloud Environment”) offer to optimize QoS criteria:
by minimizing one criterion that is an ad hoc linear combination of objectives,
by requesting the specification of performance requirements, i.e. service level agreements (SLAs),
on a single or multiple data centers.

One problem with these approaches is that:
1) they do not handle an arbitrary number of QoS criteria, and most of them only handle execution cost and time metrics;
2) the weights among the criteria must be known a priori. They are chosen in an ad hoc manner and depend on the subjective estimation of the user;
3) deciding a priori the weights of a linear combination implies leaving out some optimal solutions since the weights constrain the solution search; and
4) the size of the search graph grows exponentially with the number of services, data centers, and service providers, making the computation of the solution intractable.

This disclosure provides an efficient multi-objective optimization framework for automatically planning workflow deployment on multiple data centers (such as clouds) while optimizing multiple conflicting QoS criteria.

The workflows to be deployed are represented as graphs modeling the orchestration of abstract services (e.g. translation service). For each abstract service, multiple instantiations (e.g. Google translate, Yahoo! babel fish) offered by different providers exist. Each service instance can be hosted or executed on different data centers and therefore present QoS properties (e.g. cost, reputation, privacy) that are different at each data center.

The disclosed framework takes such abstract service workflows and QoS parameters to produce a workflow plan that decides which service instance to run on which cloud, resulting in an optimal concrete service workflow. The decision process through which the framework goes to build a solution relies on multiple explicit criteria (QoS parameters) associated with each service instance and data center. The framework is able to handle any number of criteria while avoiding combinatorial explosion due to the multi-dimensional search space. It is weight-agnostic since it does not require the specification of preferences between criteria as weight values, although this alternative is still available if required. Since the framework is theoretically grounded, the solutions it computes belong to the set of optimal solutions. Furthermore, the overall algorithm space and time complexities are practical.

As briefly discussed above, this disclosure provides for implementation of a framework which takes an abstract workflow, i.e. orchestration of abstract services, and returns an instantiated workflow, i.e. orchestration of concrete services, to be deployed on multiple data centers and optimized according to multiple criteria, i.e. QoS parameters. The optimal planning solution it builds for a given workflow and the set of criteria is obtained as presented herein.

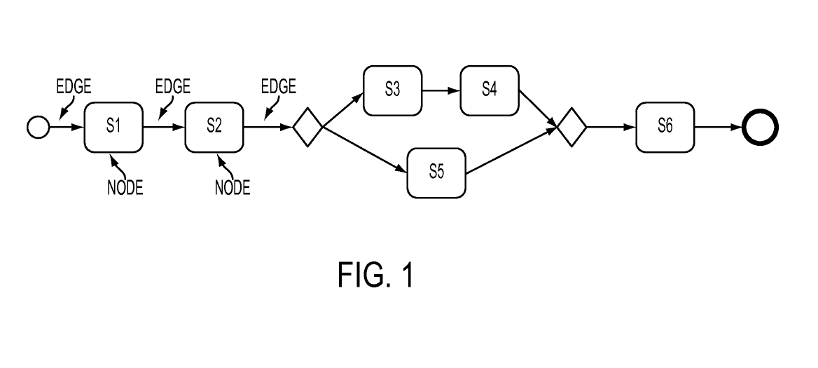

With reference to FIG. 1, the user gives an abstract workflow as an input to the framework. As depicted by FIG. 1, an abstract workflow AW is a graph <S, E> where S is the set of abstract services S1, S2, S3, S4, S5 and S6 and E the set of edges connecting them. It is typically obtained by specifying the orchestration of abstract services in a BPMS (Business Process Management System) workflow design editor. By way of example, the abstract services may include, but is not limited to, a translation service, a printing service, a cloud-based storage service.

The purpose of the framework is to: 1) instantiate AW into a concrete workflow CW that is a workflow in which service providers and data centers are specified for each node of the graph, and 2) insure that this workflow concretization is optimal with regards to a set of criteria:

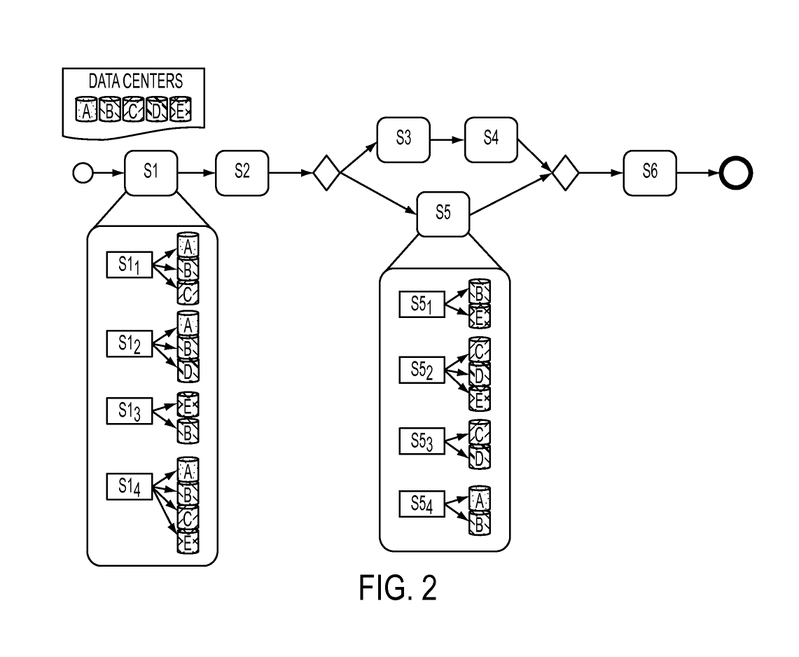

With reference to FIG. 2, instantiating an abstract workflow into a concrete workflow includes deciding: a) which service instance will be chosen for each abstract service, and b) which data center will be selected to host/execute a service instance. For example, the data centers may be a remote server, cloud, etc.

As shown in FIG. 2, abstract services S1 can be performed by any one of service instances S1₁, S1₂, S1₃ and S1₄. For example, abstract service S1 could be a translation service, and S1₁, S1₂, S1₃ and S1₄ represent providers, such as Google Translate, Yahoo!, babel fish, etc. Also, each service instance can be performed by a plurality of the data centers indicated, i.e. A, B, C, D and E. For example, service instance S1 can be hosted or provided by data center A, B or C, which could represent a specific cloud, remote server, or other business process provider, such as Amazon Elastic Cloud, Rackspace, and VMWare.

The optimality of the produced concrete workflow is obtained according to a decision function that takes into account a set of QoS criteria such as execution time, cost, availability, reputation, privacy, etc. These criteria differ for each service instance and for each cloud in which the service instance will be running. They are typically obtained by either monitoring a running concrete service or requesting the service provider.

The framework models the decision process underlying the optimal workflow instantiation as a multi-objective combinatorial optimization problem. See M. Ehrgott, X. Gandibleux, An Annotated Bibliography of Multi-Objective Combinatorial Optimization, Report in Wirtschaftsmathematik, Universitat Kaiserslautern, 60 pages, Feb. 15, 2000. It relies on a decision function that minimizes the value of the worst objective per edge at each step during the search process of the solution, which will be further explained below. This decision function ensures finding a weakly Pareto optimal solution. See M. Ehrgott, Multi-Criteria Optimization. Lecture in Wirtschaftsmathematik, Universitat Kaiserslautern, 243 pages, 2000. In other words, there is no other solution in the entire search space in which every criterion is strictly better than it is in the current optimal solution. Obtaining this solution does not require any a priori knowledge from the user regarding the preferences between criteria to optimize. Furthermore, this framework is able to handle any number of criteria while avoiding a combinatorial explosion due the number of criteria, service instances, and clouds.

The following description presents the optimization algorithm that builds the concrete workflow planning solution.

### Multi-Objective Optimization Framework for Workflow Planning

The previously defined problem is addressed as a multi-objective optimization problem. Its combinatorial structure is a shortest path problem. It is multi-objective since each edge between two nodes is valued by a vector of criteria values.

Thus, the resolution method finds the shortest path in the multi-objective graph of possible paths. This shortest path is guaranteed to be weakly Pareto optimal.

### Building the Search Graph

### Nodes:

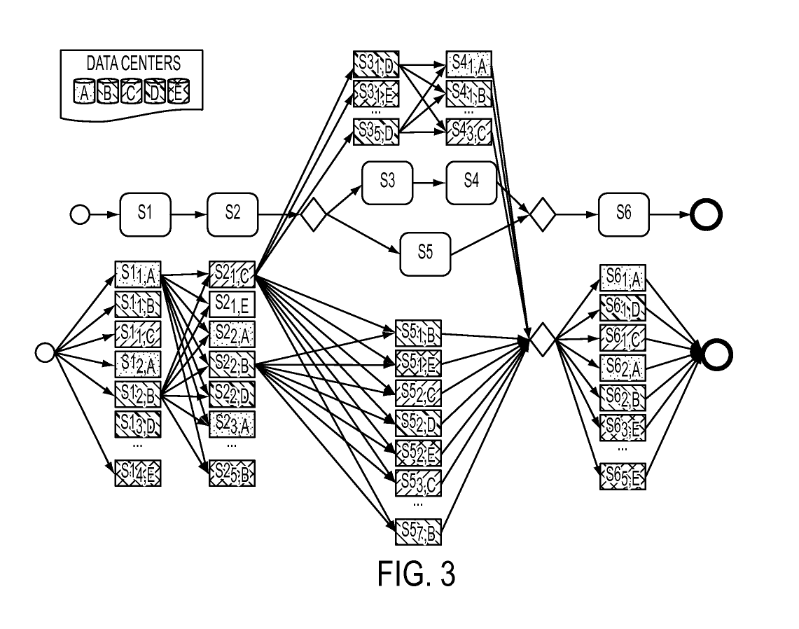

As shown in FIG. 3, initially the abstract graph AW is expanded into the search space of concrete graphs CW that describe all possible paths of service instances and data centers. This is done by expanding each abstract service node Si of AW into a set of nodes {Si_{j,d}} that is the Cartesian product between all the possible service instances {Siⱼ} and data centers {d}.

### Edges:

With continuing reference to FIG. 3, each of the expanded nodes Si_{j,d} instantiating a service Si is linked to every expanded node Si+1_{j′,d′} instantiating the service Si+1. The source node is linked to every expanded node S1_{j,d}, and every expanded node Sn_{j,d} is linked to the end node.

### Criteria:

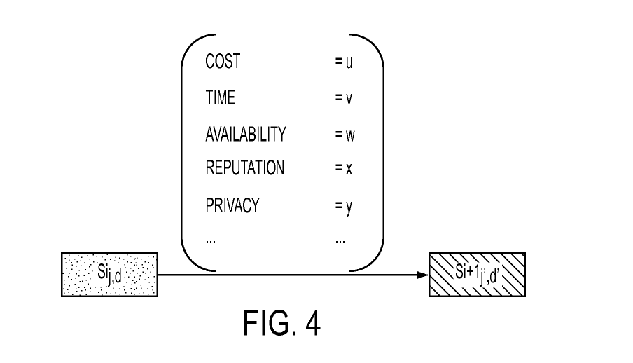

With reference to FIG. 4, each edge of the graph is labeled by a scalar vector representing the value of each criterion for traversing the edge linking node Si_{j,d} to node Si+1_{j′,d′}. In other words, given that the current path is built until service Si_{j,d}, the scalar vector models the cost for using the next service instance and data center, i.e. cost for using Si+1_{j′,d′}. Other criterion modeled includes time, availability, reputation and privacy.

### Normalization of the Criteria Values:

All criteria values are normalized between 0 and 1. In order to do so, the maximal value of each criterion max^{Criterion} is requested once from the BPMS (Business Process Management System) monitoring system. Note that this could also be done at runtime at a constant computational cost. The maximal value for each criterion is then used to compute an intermediate normalized value of that criterion associated with each edge. For instance, the intermediate normalized value of the criterion Reputation is

$${x}^{′} = \frac{Q o S [ reputation ]}{{max}^{Reputation}} ,$$

where QoS[reputation] is the value of the service reputation, and max^{Reputation} is the max value input for the Reputation criterion.

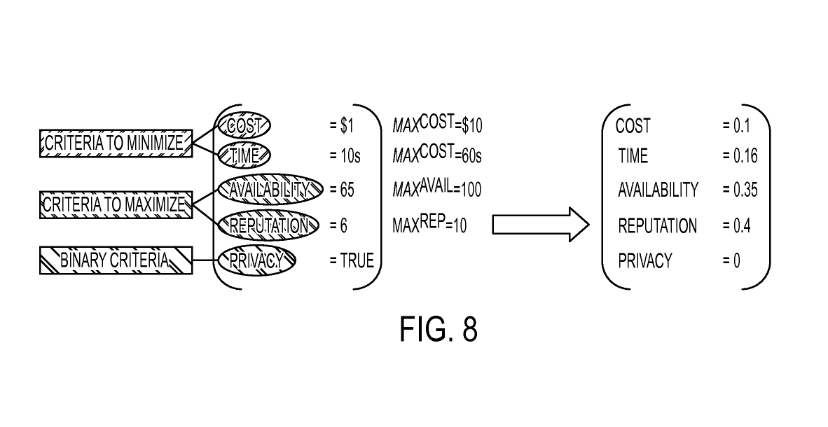

In addition, a second normalization is applied in order to use minimization over all criteria when searching for the optimal solution. More specifically:
For criteria to minimize, e.g. cost and time, the function min can be applied by default on their (intermediate) normalized values.
For criteria to maximize, e.g. availability and reputation, and if x′ is the criteria's intermediate normalized value, then minimization is applied on the computed value x=1−x′. For instance, in FIG. 8, the value of QoS[reputation]=6 and max^{Reputation}=10. The intermediate normalized value is therefore 6/10=0.6 and the final criterion value is 1−0.6=0.4. The reputation criterion can then be minimized.
For Boolean criteria, e.g. privacy, the user specifies, for each abstract service, whether it is required or not. If it is, then edges linked to concrete services that satisfy the criteria, e.g. private data centers, are assigned a value of 0, whereas those that do not, e.g. public ones, are assigned a value of 1. Criteria that are not required are given a value of 0 in all edges. Minimization can hence be used.

### Decision Function

### Optimizing Using the Max-Ordering Function:

The shortest path problem relies on a decision function that guides the search. In the classical single objective optimization problem, each edge is valued by a single criterion value. The goal then consists in finding a solution of minimal cost, i.e. by selecting the edges minimizing the criterion value.

In the multi-objective configuration, objectives are often contradictory. Therefore, simultaneously optimizing all the criteria is not possible. To cope with this problem, existing approaches use a linear combination of several objectives into a single objective to cast the problem into the classical shortest path problem. See K. Kofler, I. ul Haq, E. Schikuta, A Parallel Branch and Bound Algorithm for Workflow QoS Optimization, In Proceedings of the International Conference on Parallel Processing, pages 478-485, 2009; and U.S. patent application Ser. No. 13/192,221, filed Jul. 27, 2011, by Jung et al. and entitled “Methods And Systems For Deploying A Service Workflow In A Hybrid Cloud Environment”. The drawback of this method is that the user needs to specify each weight in the linear combination. Those weights require a priori knowledge or preferences among all the criteria which the user does not necessarily have or want to specify.

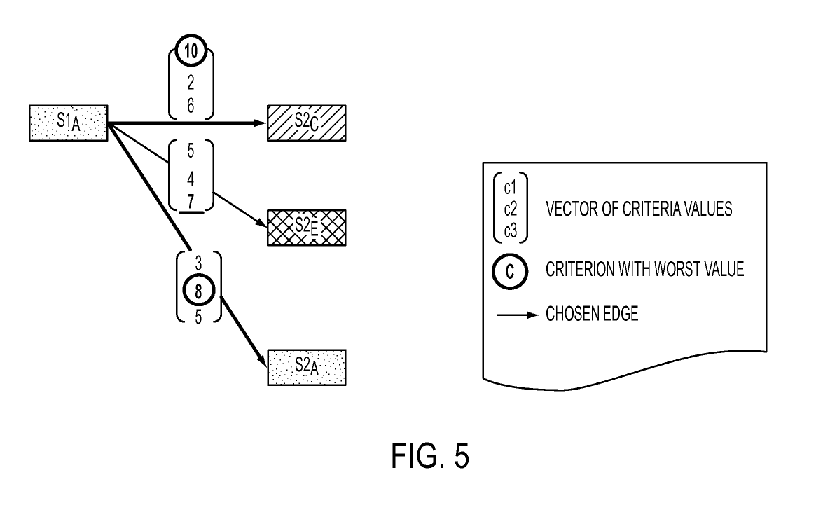

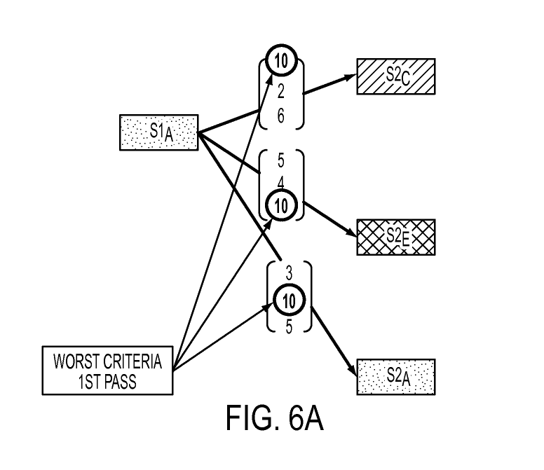

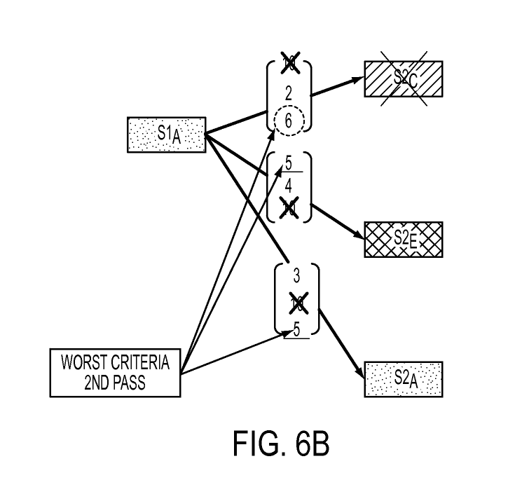

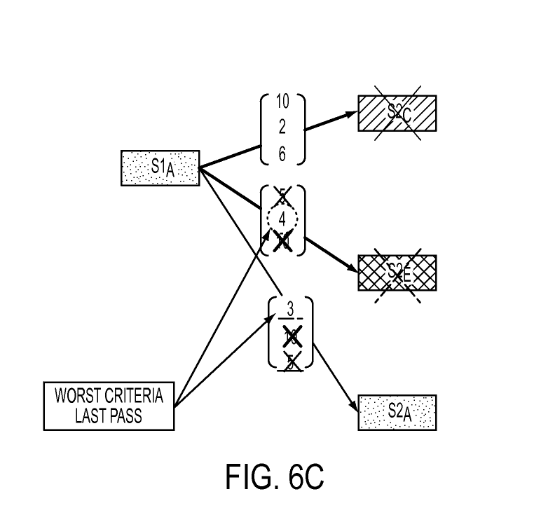

As a decision function, instead, the max-ordering optimization function is adopted. See M. Ehrgott, Multi-Criteria Optimization. Lecture in Wirtschaftsmathematik, Universitat Kaiserslautern, 243 pages, 2000. As illustrated in FIG. 5, it consists in choosing at each step of the search the edge whose worst criterion value is minimal among all edges. If all edges have an equal worst value, then max-ordering is applied on the next worst value as illustrated in FIGS. 6A-6C. This decision function ensures finding an optimal solution without any a priori knowledge of the decision problem by the user. Furthermore, it is well suited for handling any number of criteria as no adaptation of the function is necessary for handling vectors of any size.

For example, as shown in FIG. 5, service instance S2_{C} includes a maximum cost value of 10, S2_{E} includes a maximum cost value of 7 and S2_{A} includes a maximum cost value of 8. Notably, the maximum cost values are associated with data centers C, E and A, respectively, and the maximum cost values are associated with different criterion values, for example cost value 10 may be associated with time, cost value 7 may be associated with reputation and cost value 8 may be associated with availability. As shown in FIG. 5, service instance S2_{E} is chosen because it has the minimum worst criterion value, 7.

### Variations:

Notably, other decision functions can be used instead of max-ordering depending on the definition of the problem. For example, if preferences among criteria exist, the lexicographic-max-ordering function can be used. See M. Ehrgott, A Characterization of Lexicographic Max-Ordering Solutions. In Proceedings of the 6th Workshop of the DGOR working group Multi-Criteria Optimization and Decision Theory, pages 1-10, 1997. It consists in applying the max-ordering function criteria by criteria from the most important criteria to the least preferred one.

Also note that the framework presented here produces one optimal planned workflow solution. However, the decision function can also be used to obtain a ranking of several optimal solutions. For example, at each step of the search, rather than considering only the best option for the max-ordering, the framework would consider the top k options of that max-ordering.

### Parallel Branches

The term branch is used to refer to the sub-graphs linking a split node to a join node, e.g. in FIG. 1, S3, S4 is one branch, and S5 is another. This framework handles parallel branches by exploring the different paths at the split nodes, i.e. AND/OR/XOR gates for workflows, and therefore applying the decision function on each resulting path.

When a split node appears, the sub-graphs are explored in parallel. Those explorations are performed the same way as in the general search.

When the branches converge, every end node of each branch is linked to the same join node, as instances of services S4 and S5 in FIG. 3 illustrate. The usual max-ordering is then applied to choose the next service instance and data center following this join node, as illustrated with the converging node linked to the instances of service S6.

The use of join nodes avoids the combinatorial explosion due to the parallel branches, especially in the case of workflows with many parallel branches.

### QoS Estimation of the Final Path

For criteria such as availability, privacy, and reputation, an average value over the solution path can be computed as a global cost estimation for the workflow.

For criteria such as time and cost, the estimation of the final value is obtained by aggregating the criterion value at each step of the search. The aggregation function varies according to the natures of both the criterion and the previous step, i.e. sequential or parallel, in the search:

For sequential steps, the aggregated time and cost are both obtained by accumulating the criteria value over the steps.

For AND-parallel steps, the aggregated time is the maximum between the cumulative time criteria of all branches; and the aggregated cost is the cumulative value of the cost criteria over all the branches.

For (X)OR-parallel steps, the aggregated time and cost are both the maximum between the criteria of each branch.

### Algorithm Complexity

Given the design of the search graph described above with reference to FIG. 3, the topology of the search graph is known. Furthermore, by using the max-ordering decision function, the optimal solution is computed by exploring a single path in the search graph. Hence, the time and space complexities of the algorithm are given by the following formula:

O((n+b)× q̅× d̅×c)

Such that:

n is the number of abstract services.

b is the number of branch joins.

q̅ is the average number of service instances for each abstract service.

d̅ is the average number of available data centers for each service instance.

c is the number of QoS criteria considered.

An empirical analysis of the complexity factors reveals that, in a typical workflow, the main factor contributing to the complexity of the algorithm is the number of service providers. All the other factors remain bounded by small numbers. Hence, the overall space and time complexities remain practical.

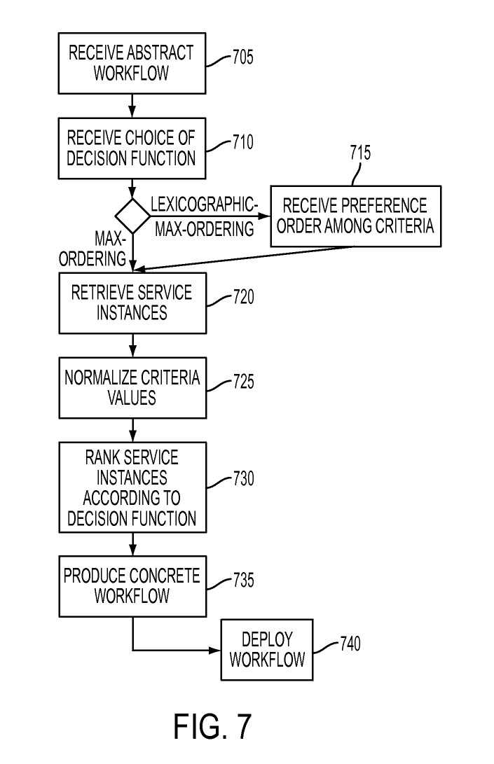

With reference to FIG. 7, illustrated is a flow chart of a method of deploying a service workflow for a business process according to an exemplary embodiment of this disclosure.

Initially, a computing device, such as a desktop computer, receives an abstract workflow description 705. In other words, a control flow of service types to be executed is received. Included as part of the abstract workflow description or provided in step 710, a choice of decision function is provided: 1) max-ordering, i.e. the user wants to optimize all the criteria at the same time; or 2) lexicographic-max-ordering, i.e. the user has a preference order among the criteria to optimize, which is provided at step 715.

Next, the computer device retrieves service instances 720. For each service type in the abstract workflow, service instance options are retrieved from each data center, for example service instances which are hosted on particular clouds.

Next, the criteria values are normalized 725. Specifically, the criteria values V of the service instances are normalized according to one of the following:

Criteria to minimize: V/max^{Criteria};

Criteria to maximize: 1−(V/max^{Criteria}); and

Binary criteria: 0 if it meets the user need, otherwise 1.

Next, the processor ranks service instances according to the decision function 730. Specifically, the decision function max-ordering or lexicographic-max-ordering is applied to select a service instance per service type.

Next, a concrete workflow is produced 735, the concrete workflow including the selected service instances provided by the selected decision function.

Finally, the concrete workflow is deployed 740 to the appropriate data centers for execution.

With reference to FIG. 8, illustrated is an example of the step of normalizing criteria values previously described.

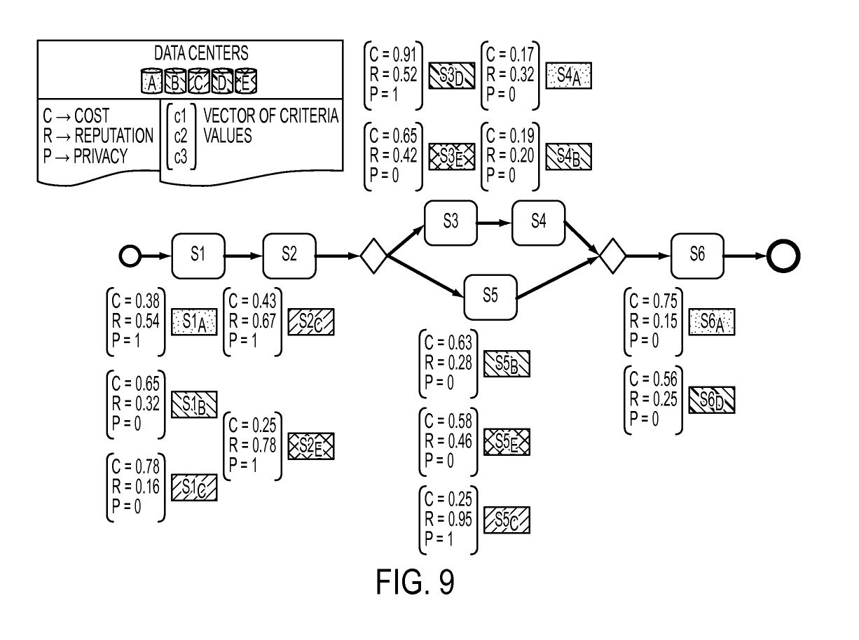

With reference to FIG. 9, illustrated is an example of a service workflow deployment method according to an exemplary embodiment of this disclosure.

As shown, the abstract workflow includes service types S1, S2, S3, S4, S5 and S6.

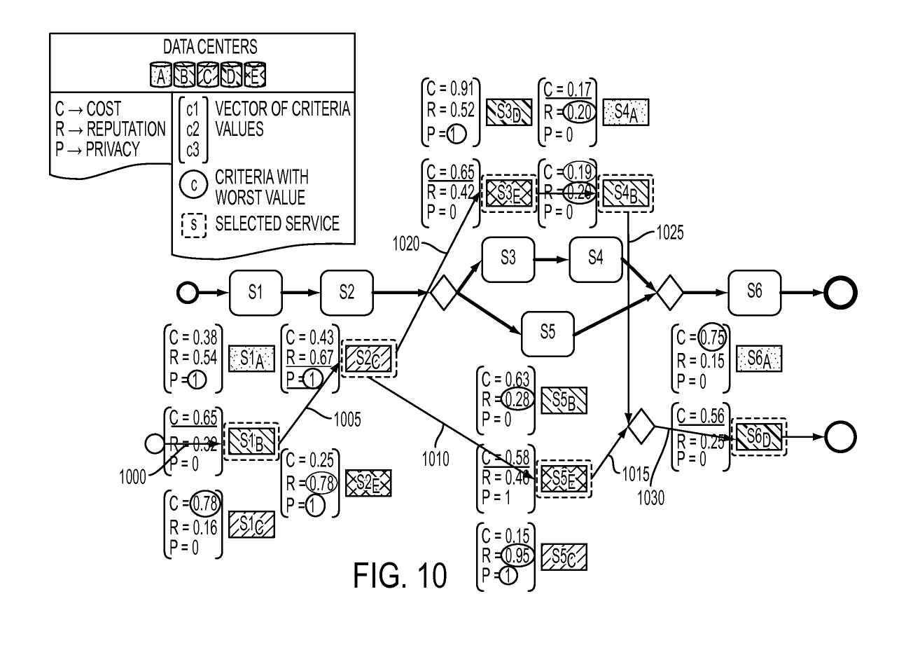

FIG. 10 shows the execution of a max-ordering decision function as applied to the workflow of FIG. 9. As shown, edges 1000, 1005, 1010, 1015, 1020, 1025 and 1030, provide the resulting path of service instantiations to be executed by the indicated data centers.

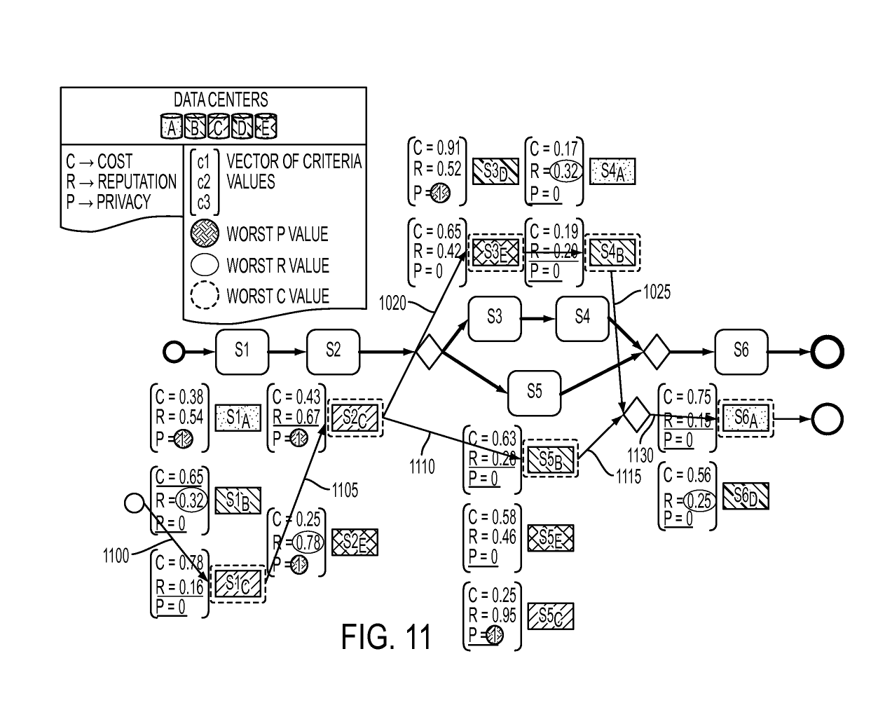

FIG. 11 shows the execution of a Lexicographic-max-ordering decision function as applied to the workflow of FIG. 9. As shown, edges 1100, 1105, 1110, 1115, 1020, 1025 and 1130 provide the resulting path of service instantiations to be executed by the indicated data centers. Notably edges 1020 and 1025 also are the resultant edges for the max-ordering decisions function as shown in FIG. 10.

FIG. 12 depicts a block diagram of exemplary internal hardware that may be used to contain or implement program instructions, such as the process steps discussed above in reference to FIG. 7, according to embodiments. A bus 1200 serves as the main information highway interconnecting the other illustrated components of the hardware. CPU 1205 is the central processing unit of the system, performing calculations and logic operations required to execute a program. CPU 1205, alone or in conjunction with one or more of the other elements disclosed in FIG. 12, is an exemplary processing device, computing device or processor as such terms are used within this disclosure. Read only memory (ROM) 1210 and random access memory (RAM) 1215 constitute exemplary memory devices (i.e., processor-readable non-transitory storage media).

A controller 1220 interfaces with one or more optional memory devices 1225 to the system bus 1200. These memory devices 1225 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 1210 and/or the RAM 1215. Optionally, the program instructions may be stored on a tangible computer readable medium such as a compact disk, a digital disk, flash memory, a memory card, a USB drive, an optical disc storage medium, such as a Blu-ray™ disc, and/or other non-transitory storage media.

An optional display interface 1230 may permit information from the bus 1200 to be displayed on the display 1235 in audio, visual, graphic or alphanumeric format. Communication with external devices, such as a print device, may occur using various communication ports 1240. An exemplary communication port 1240 may be attached to a communications network, such as the Internet or an intranet.

The hardware may also include an interface 1245 which allows for receipt of data from input devices such as a keyboard 1250 or other input device 1255 such as a mouse, a joystick, a touch screen, a remote control, a pointing device, a video input device and/or an audio input device.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated herein, and described throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method of deploying a service workflow for a business process, the method comprising:
A) receiving, by a computing device, a service workflow including an ordered plurality of services, each service associated with a plurality of instantiations, and each instance associated with a plurality of data centers to provide the respective instance, each data center associated with one or more QoS properties;
B) building a search graph based on the service workflow including a search space of concrete graphs that describe all possible paths of service instances and data centers;
C) applying a max ordering function to the search graph to determine the instance and data center for each service; and
D) deploying the service workflow to the determined data centers to provide the execution of the service workflow.

2. The method according to claim 1, wherein the max-ordering function is one of a max-ordering optimization function and a lexicographic-max-ordering function.

3. The method according to claim 1, wherein the QoS properties are one or more of execution time, cost, availability, reputation and privacy.

4. The method according to claim 1, wherein the search graph includes nodes, edges and normalized criteria values.

5. The method according to claim 1, wherein the method is deployed in a cloud environment.

6. The method according to claim 1, wherein the plurality of services include one or more of a translation service, a cloud-based storage service, a printing service, a login service, and a travel-request approval service.

7. The method according to claim 1, wherein step D) obtains a ranking of several solutions, each solution providing a unique pair of an instance and a data center for each service.

8. A system for deploying a service workflow for a business process, the system comprising:
a processor;
a processor-readable non-transitory storage medium in communication with the processor, the processor-readable non-transitory storage medium containing one or more programming instructions that, when executed, cause the processor to:
A) receive a service workflow including an ordered plurality of services, each service associated with a plurality of instantiations, and each instance associated with a plurality of data centers to provide the respective instance, each data center associated with one or more QoS properties;
B) build a search graph based on the service workflow including a search space of concrete graphs that describe all possible paths of service instances and data centers;
C) apply a max ordering function to the search graph to determine the instance and data center for each service; and
D) deploy the service workflow to the determined data centers to provide the execution of the service workflow.

9. The system for deploying a service workflow for a business process according to claim 8, wherein the max-ordering function is one of a max-ordering optimization function and a lexicographic-max-ordering function.

10. The system for deploying a service workflow for a business process according to claim 8, wherein the QoS properties are one or more of execution time, cost, availability, reputation, and privacy.

11. The system for deploying a service workflow for a business process according to claim 8, wherein the search graph includes nodes, edges and normalized criteria values.

12. The system for deploying a service workflow for a business process according to claim 8, wherein the method is deployed in a cloud environment.

13. The system for deploying a service workflow for a business process according to claim 8, wherein the plurality of services include one or more of translation service, cloud-based storage service, billing service, and login service.

14. The system for deploying a service workflow for a business process according to claim 8, wherein step D) obtains a ranking of several solutions, each solution providing a unique pair of an instance and a data center for each service.

15. A computer program product comprising:
a computer-usable non-transitory data carrier storing instructions that, when executed by a computer, cause the computer to perform a method of deploying a service workflow for a business process, the method comprising:
A) receiving, by a computing device, a service workflow including an ordered plurality of services, each service associated with a plurality of instantiations, and each instance associated with a plurality of data centers to provide the respective instance, each data center associated with one or more QoS properties;
B) building a search graph based on the service workflow including a search space of concrete graphs that describe all possible paths of service instances and data centers;
C) applying a max ordering function to the search graph to determine the instance and data center for each service; and
D) deploying the service workflow to the determined data centers to provide the execution of the service workflow.

16. The computer program product according to claim 15, wherein the max-ordering function is one of a max-ordering optimization function and a lexicographic-max-ordering function.

17. The computer program product according to claim 15, wherein the QoS properties are one or more of execution time, cost, availability, reputation and privacy.

18. The computer program product according to claim 15, wherein the search graph includes nodes, edges and normalized criteria values.

19. The computer program product according to claim 15, wherein the method is deployed in a cloud environment.

20. The computer program product according to claim 15, wherein the plurality of services include one or more of a translation service, a cloud-based storage service, a printing service, a login service, and a travel-request approval service.

21. The computer program product according to claim 15, wherein step D) obtains a ranking of several solutions, each solution providing a unique pair of an instance and a data center for each service.
